(19) United States
(12) Patent Application Publication
(10) Pub. No.: US 2025/0020490 A1
(43) Pub. Date: Jan. 16, 2025

(54) CYLINDER WITH INTEGRAL POSITION SENSOR

(71) Applicant: UNIVERSITÉ D'EVRY VAL D'ESSONNE, EVRY-COURCOURONNES (FR)

(72) Inventors: Samer ALFAYAD, EVRY (FR); Mohamad KARDOFAKI, EVRY (FR); Maya SLEIMAN, EVRY (FR); Richard ARLOT, BONNEVENT-VELLOREILLE (FR)

(21) Appl. No.: 18/711,493

(22) PCT Filed: Nov. 16, 2022
(86) PCT No.: PCT/EP2022/082142

§ 371 Date: May 17, 2024

(30) Foreign Application Priority Data
Nov. 19, 2021 (FR) FR2112268

(51) Int. Cl. G01D 5/245; F15B 15/28

(52) U.S. Cl. CPC G01D 5/2451; F15B 15/2853; G01D 2205/18

(57) ABSTRACT

A cylinder actuator includes two elements mobile one relative to the other along an axis of movement and a position sensor configured to measure the relative position of the two elements, the position sensor comprising a multi-pole magnetic strip secured to a first of the two elements and a sensitive element sensitive to magnetic-field variations and secured to a second of the two elements, the multi-pole magnetic strip having an alternation of north and south poles extending in an interval that defines a measurement range for the measurement of the relative position along the axis of movement, the sensitive element being arranged in such a way as to detect variations in the magnetic field in the vicinity of the multi-pole magnetic strip along the axis of movement within the interval.

### CROSS-REFERENCE TO RELATED APPLICATIONS

This application is a National Stage of International patent application PCT/EP2022/082142, filed on Nov. 16, 2022, which claims priority to foreign French patent application No. FR 2112268, filed on Nov. 19, 2021, the disclosures of which are incorporated by reference in their entireties.

### FIELD OF THE INVENTION

The invention relates to a cylinder with integral position sensor. There are numerous types of cylinders used as actuators. The cylinder actuators cause a mechanical member to move with respect to a fixed point. The movement may be a rotational or a translational movement. Cylinder actuators that bring about a rotational movement are generally referred to as rotary cylinder actuators and cylinder actuators that bring about a translational movement are generally referred to as linear cylinder actuators.

### BACKGROUND

There are various forms of energy that may move the mobile part of the cylinder actuator. By way of example, mention may be made of electrical, pneumatic or hydraulic energy that causes the mobile part of a cylinder actuator to move. The invention may be implemented irrespective of the form of energy used to move the mobile part of the cylinder actuator.

A cylinder actuator is generally a component that can be purchased from a specialist manufacture for integration into a complex system. In this system, it is beneficial to know the relative position of the mobile part of the cylinder actuator with respect to the fixed part thereof, notably so as to automatically control the position of the mobile part. Numerous position sensors that are independent of the cylinder actuators exist and may be integrated into the systems that employ a cylinder actuator. By way of example, an optical sensor allows the position of the mobile part to be viewed. This sensor is connected to a control module of the cylinder actuator and allows control of this cylinder actuator.

The use of sensors external to the cylinder actuator entails connections which may present risks, notably on account of the presence of mechanical moving parts. The solution most commonly employed for transmitting information between a mobile sensor and a fixed element of the system is to connect the sensor using electric cables. The electric cables run along the connecting elements connecting the fixed element to the mobile element bearing the sensor. The cables need to pass through the articulations that connect to the various elements to one another. These cables run the risk of becoming damaged during use of the equipment, for example by snagging on an external object. It is possible to fit fairings over these cables in order to protect them. The fairings constitute additional mechanical parts occupying volumes that cannot be cleared. In addition, the cables often carry low-intensity electrical signals liable to be disturbed by the electromagnetic environment of the system. For example, sensors of the piezoelectric type deliver signals that are particularly weak. The cables associated with these sensors cannot be long because a great length will result in degradation of the information coming from the sensor.

### SUMMARY OF THE INVENTION

The invention proposes integrating a position sensor into a cylinder actuator, so that the connections between the sensor and the cylinder actuator can become independent of the system in which the cylinder actuator is used. This integration makes it possible to simplify the production of a system using the cylinder actuator as the designers of the system need not concern themselves with the siting and connecting of the sensor. Integrating the sensor also allows better control over the connection of the sensor which is connected only to the cylinder actuator itself and not to the environment thereof.

To this end, the invention relates to a cylinder actuator comprising two elements mobile one relative to the other along an axis of movement and a position sensor configured to measure the relative position of the two elements, the position sensor comprising a multi-pole magnetic strip secured to a first of the two elements and a sensitive element sensitive to magnetic-field variations and secured to a second of the two elements, the multi-pole magnetic strip having an alternation of north and south poles extending in an interval that defines a measurement range for the measurement of the relative position along the axis of movement, the sensitive element being arranged in such a way as to detect variations in the magnetic field in the vicinity of the multi-pole magnetic strip along the axis of movement within the interval.

The two elements may be translationally mobile one with respect to the other, the axis of movement being an axis of translation, the cylinder actuator comprising a cylinder body and a piston secured to a rod and mobile along the axis of translation with respect to the cylinder body, the piston and the multi-pole magnetic strip each having a circular cross section perpendicular to the axis of movement.

The multi-pole magnetic strip may comprise an alternation of permanent magnets, the axes of the poles of the permanent magnets being perpendicular to the axis of translation.

Alternatively, the multi-pole magnetic strip may comprise an alternation of permanent magnets and of concentrators comprising a ferromagnetic material, the axes of the poles of the permanent magnets being parallel to the axis of translation, and the axes of the poles being oriented in opposite directions in each pair of consecutive permanent magnets separated by a concentrator.

Advantageously, the concentrators have a shape of which a dimension parallel to the axis of translation increases with increasing proximity to the sensitive element.

Advantageously, for each concentrator, at a part of the concentrator that is furthest from the sensitive element, the dimension parallel to the axis of translation remains constant with varying distance to the sensitive element.

Advantageously, the cylinder actuator comprises an additional concentrator, the sensitive element being arranged between the magnetic strip and the additional concentrator.

In one particular embodiment, the first of the two elements comprises a cylinder body of the cylinder actuator, the second of the two elements comprising a piston and a rod which are secured to one another, the sensitive element being fixed to the piston, the cylinder actuator further comprising a telescopic connection arranged in a chamber of the cylinder actuator in which chamber the piston moves, and allowing transmission, from the sensitive element toward the cylinder body, of information relating to the magnetic-field variations detected by the sensitive element.

Advantageously, the multi-pole magnetic strip, secured to the cylinder body, forms a liner into which the piston is closely fitted.

Advantageously, the rod of the cylinder actuator comprises a hollow internal space extending along the axis of movement and the magnetic strip is formed on a finger secured to the cylinder body, the finger being arranged inside the hollow internal space.

Advantageously, the cylinder actuator further comprises a force sensor arranged on the rod and transmitting to the cylinder body measurements of the force exerted by the rod along the axis of movement toward the cylinder body by means of the telescopic connection.

In another particular embodiment, the first of the two elements comprises a piston and a rod which are secured to one another, the second of the two elements comprises a cylinder body of the cylinder actuator, the sensitive element being fixed to the cylinder body.

### BRIEF DESCRIPTION OF THE DRAWINGS

The invention will be better understood and other advantages will become apparent on reading the detailed description of an embodiment given by way of example, which description is illustrated by the appended drawing, in which:

FIG. 1 is a perspective depiction of a linear cylinder actuator into which a position sensor is integrated;

FIG. 2 depicts, in cross section, a first embodiment of a cylinder actuator according to the invention;

FIGS. 3, 4 and 5 depict details of the first embodiment of FIG. 2;

FIG. 6 depicts a variant of the first embodiment of a cylinder actuator according to the invention;

FIG. 7 depicts a second embodiment of a cylinder actuator according to the invention;

FIG. 8 depicts a detail of the second embodiment of FIG. 7;

FIG. 9 depicts a third embodiment of a cylinder actuator according to the invention;

FIG. 10 depicts a detail of the third embodiment of FIG. 9;

FIGS. 11 and 12 depict two embodiments of a multi-pole magnetic strip with which a cylinder actuator according to the invention is equipped;

FIGS. 13, 14 and 15 depict different variants of concentrators with which the multi-pole magnetic strip of FIG. 12 is equipped;

FIGS. 16 and 17 depict a variant embodiment of a cylinder actuator according to the invention, in which an additional concentrator is added.

For the sake of clarity, the same elements bear the same reference signs in the various figures.

### DETAILED DESCRIPTION

The various figures describe a number of embodiments of a linear cylinder actuator. It is of course possible to implement the invention in the case of a rotary cylinder actuator in which there is a desire to determine the angular position of the mobile part of the cylinder actuator with respect to the fixed part thereof. Likewise, the cylinder actuators described employ hydraulic or pneumatic energy in order to move them. The invention may also be implemented with cylinder actuators using other forms of energy, notably electrical energy.

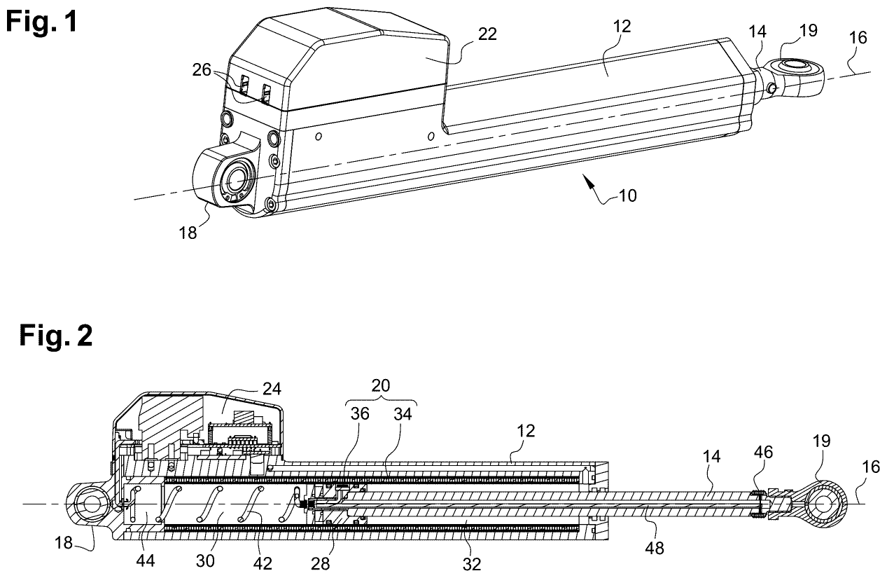

FIG. 1 is a perspective depiction of a linear cylinder actuator 10. The cylinder actuator 10 comprises a cylinder body 12 and a rod 14 able to move in translation along an axis 16 with respect to the cylinder body 12 of the cylinder actuator 10. The cylinder actuator 10 comprises means for attaching its cylinder body 12 and its rod 14 into a system. In the example depicted, the cylinder actuator 10 comprises a first ring 18 secured to the cylinder body and a second ring 19 secured to the rod 14 and located at the rod end that protrudes from the cylinder body 12. The rings 18 and 19 on the one hand enable the cylinder body 12 to be attached to a supporting structure of the system and on the other hand enable the rod 14 to be attached to a mobile object of the system capable of moving relative to the supporting structure. The rings 18 and 19 offer the advantage of attaching the cylinder actuator to the system by means of pivoting or ball-jointed connections. Other means of attachment are also conceivable. It is notably possible to attach the cylinder body 12 by means of a joint having no degrees of freedom. The cylinder body 12 has an elongate shape in which the rod 14 is housed. In the example depicted, the cylinder body 12 comprises a protuberance 22 in which a control module 24 for controlling the cylinder actuator may be placed. One face of the protuberance 22 may have connections 26 for connecting the control module 24. The connections 26 may carry power and control signals. The power is supplied to the cylinder actuator 10 in an appropriate form, for example in the form of pneumatic, hydraulic or electrical energy.

FIG. 2 illustrates a first embodiment of the invention. FIG. 2 is a cross-sectional depiction of the cylinder actuator 10 into which there is integrated a position sensor 20 making it possible to determine the relative position of the rod 14 in its movement with respect to the cylinder body 12 along the axis 16. In practice, a position sensor also means a speed sensor and an acceleration sensor. From the position, it is possible to obtain speed and/or acceleration information by differentiating the position information with respect to time. Conversely, from a speed or acceleration sensor it is also possible to obtain position information by integrating with respect to time.

In the example depicted, the cylinder actuator 10 is a hydraulic cylinder. More specifically, the cylinder actuator 10 comprises a piston 28 separating two chambers 30 and 32. The rod 14 is secured to the piston. The two chambers are created in a cylindrical volume extending along the axis 16. Supplying hydraulic fluid to the two chambers 30 and 32 enables the piston 28 to be moved by varying the relative pressure of the fluid in each of the chambers 30 and 32. The control module 24 may comprise a hydraulic distributor for supplying the chambers 30 and 32.

The position sensor 20 comprises a multi-pole magnetic strip 34 secured to the cylinder body 12 and a sensitive element 36 sensitive to variations in the magnetic field in the vicinity of the magnetic strip 34, along said strip. The sensitive element 36 is secured to the piston 28 and therefore to the rod 14. The magnetic strip 34 has an alternation of north and south poles extending in an interval that defines a measurement range for the measurement of the relative position of the piston 28 with respect to the cylinder body 10 along the axis 16. The measurement range advantageously covers the entire travel of the piston 28. In other words, the magnetic strip 34 extends along the axis 16 facing the sensitive element 36 along the entire travel thereof.

The sensitive element 36 is able to detect a variation in the magnetic field in a tight angular sector about a radial direction with respect to the axis 16. Because the rod 14 moves translationally along the axis 16, it is entirely possible to create a magnetic strip 34 that extends radially about the axis 16 in only the angular sector in which the sensitive element 36 provides detection. However, the piston 28 may have a circular cross section about the axis 16. The cylindrical volume delimiting the two chambers 30 and 32 is a close fit with the piston 28 and, like the piston 28, has the same circular cross section about the axis 16. This circular cross section makes it easier to achieve sealing between the two chambers 30 and 32 and allows the ring 19 secured to the end of the rod 14 to rotate, the rotation being about the axis 16. This rotation makes it easier to install the cylinder actuator 10 in its environment by allowing the rod 14 to maintain a degree of freedom in rotation. In order to allow the rod 14, and therefore the piston 28, to rotate, the magnetic strip 34 is not limited to the angular sector covered by the sensitive element 36 and it too then has a circular cross section about the axis 16. In other words, the magnetic strip 34 extends both along the axis 16 and also fully around same. Thus, the sensitive element 36 is able to rotate about the axis 16 with no change to its measurements along the axis 16. The magnetic strip 34 may be used as a wall of the chambers 30 and 32. In other words, the magnetic strip 34 forms a liner into which the piston 28 is closely fitted.

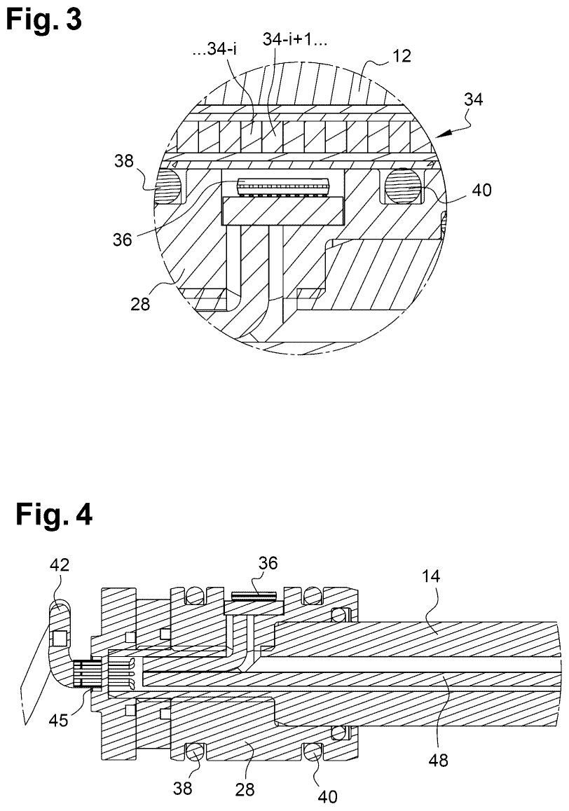

FIG. 3 depicts, in partial section, the piston 28 and the cylinder body 12 around the sensitive element 36. On each side of the sensitive element 36, the piston 28 is equipped with two O-ring seals 38 and 40, sealing against the chambers 30 and 32 respectively. In addition to providing sealing for the chambers, the seals 38 and 40 prevent the hydraulic fluid supplied to the chambers 30 and 32 from coming into contact with the sensitive element 36. Any other form of seal is equally possible.

The magnetic strip 34 is formed of rings 34-i stacked along the axis 16. The rings 34-i are visible via their edge face in FIG. 3.

FIG. 4 depicts, in cross section, the piston 28 and part of the rod 14. The processing of the information emanating from the sensitive element 36 may be performed in the control module 24 secured to the cylinder body 12. A connection ensures the transmission, to the control module 24, of information gathered by the sensitive element 36 and relating to the variations in the magnetic field as the sensitive element moves. This connection may be a wireless connection and it may be necessary to make provision for supplying power to the sensitive element 36. This supply of power may be performed through a reserve of energy integrated into the sensitive element 36, for example a battery integrated into the piston 28. Power may also be supplied by remote transmission, for example by means of magnetic induction.

As an alternative to a wireless connection connecting the control module 24 and the sensitive element 36, it is possible for the control module 24 and the sensitive element 36 to be connected using a wired connection. Such a connection may then be used both for transmitting information gathered by the sensitive element 36 and for powering the sensitive element 36. One example of a wired connection is a telescopic connection 42 connecting the sensitive element 36 mounted in the piston 28 to the cylinder body 12 and more specifically to the control module 24. It is possible to create a telescopic connection that deploys on the outside of the cylinder body 12 and that connects the control module 24 and the rod 14. Alternatively, the telescopic connection 42 is arranged inside the cylinder body 12, which enables it to be protected from potential external attack, mechanical or electromagnetic attack. The telescopic connection 42 may be arranged inside a cowling provided on the outside of the chambers. Advantageously, in order to benefit from certain spaces that already exist within the cylinder actuator 10, as depicted in FIG. 2, the telescopic connection 42 has a helicoidal form wound inside one of the chambers 30 or 32, and notably the chamber 30, making it possible to avoid the need for an additional cowling on the outside of the chambers 30 and 32. In instances in which a hydraulic fluid is used to move the cylinder actuator 10, it is advantageous for the telescopic connection 42 to be covered with a material impervious to the fluid employed. In the case of a pneumatically or electrically moved cylinder actuator, sealing of the telescopic connection 42 is not theoretically necessary. The chamber 30 comprises a volume 44 in which the telescopic connection 42 can be stowed when the rod 14 is in its position of greatest retraction into the cylinder body 12. In this position of the rod 14, the coils of the helicoidal connection 42 are mutually touching and all arranged inside the volume 44. When the rod 14 is extended out of the cylinder body 12, the coils of the helicoidal connection 42 move further apart. FIG. 4 shows a connector 45 able to connect the helicoidal connection 42 to the sensitive element 36. The connector 45 is advantageously fluidtight.

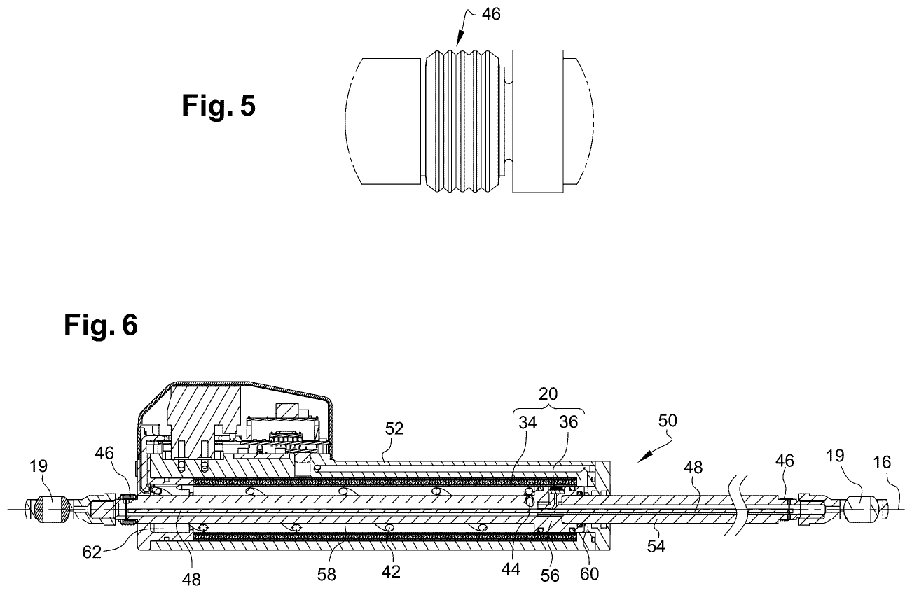

FIG. 5 depicts a force sensor 46 with which the cylinder actuator 10 may be equipped. The force sensor 46 is able to measure the load applied by the rod 14 of the cylinder actuator 10 when the cylinder actuator 10 is operated. The force sensor 46 is arranged on the rod 14. The force sensor 46 comprises for example one or more strain gauges placed on an external face of the rod 14. When the rod 14 applies loads along the axis 16, for example in order to move an object fixed to the ring 19, the external faces of the rod 14 deform. By measuring this deformation, the load applied by the rod 14 can be determined. The force sensor 46 transmits the information that it collects to the control module 24. In order to provide for this transmission, it is advantageous to use the helicoidal connection 42 already present in the cylinder actuator 10. A cable 48 connects the connector 45 and the force sensor 46.

FIG. 6 depicts a cylinder actuator 50 forming a variant of the first embodiment. The cylinder actuator 50 is known as a double-rod cylinder actuator. More specifically, the cylinder actuator 50 comprises a cylinder body 52 and a rod 54 passing right through the cylinder body 52 along the axis of translation 16. Each end of the rod 54 is equipped with a fixing element such as a ring 19 for example that can be fixed to an object that is to be moved. A piston 56 is secured to the rod 54. The piston 56 separates two chambers 58 and 60. The piston 56 is situated midway between the ends of the rod 54. In FIG. 6, the rod 54 is depicted at the end of its travel on the right-hand side of the figure. The chamber 60 is at its minimum volume and the chamber 58 is at its maximum volume. Once again, the cylinder actuator 50 includes the position sensor 20 comprising the multi-pole magnetic strip 34 secured to the cylinder body 52 and the sensitive element 36 secured to the piston 56. Once again likewise there is the telescopic connection 42 connecting the sensitive element 36 to the cylinder body 52. The telescopic connection 42 is arranged in a spiral around the rod 54 in the chamber 58. In the position of the rod 54 that is depicted in FIG. 6, the telescopic connection 42 is deployed to its maximum extent. In the opposite extreme position in which the chamber 58 occupies its minimum volume, the telescopic connection 42 is retracted to its maximum extent and its coils are mutually touching and arranged inside the volume 62 which is similar to the volume 44. Inside the volume 62, the coils of the telescopic connection 42 surround the rod 54.

The cylinder actuator 50 may be equipped with two force sensors 46, each one arranged at one end of the rod 54. The force sensors 46 transmit the information that they collect through a respective cable 48 of the connector 45 and of the telescopic connection 42.

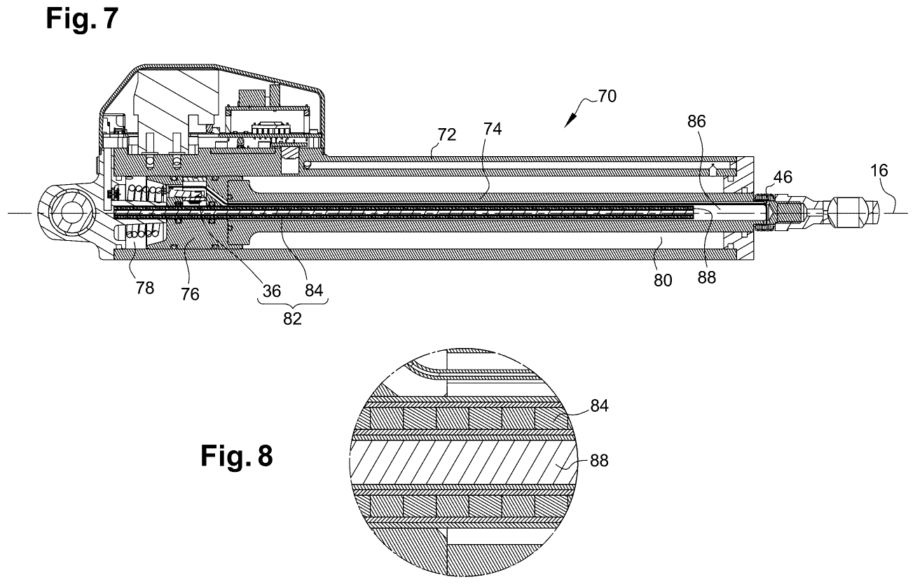

FIGS. 7 and 8 illustrate a second embodiment of the invention in which, in a cylinder actuator 70 there are once again a cylinder body 72, a rod 74, a piston 76 secured to the rod 74 and delimiting two chambers 78 and 80, and also a position sensor 82. In this embodiment, the position sensor 82 comprises a magnetic strip 84 extending inside the rod 74. More specifically, the rod 74 comprises a hollow internal space 86 extending along the axis of translation 16. The magnetic strip 84 is formed on a finger 88 secured to the cylinder body 72. The rod 74 slides around the finger 88 and around the magnetic strip 84, along the axis 16. The sensitive element 36 is secured to the piston 76 and is positioned facing the magnetic strip 84. This embodiment offers the advantage of a magnetic strip 84 of smaller cross section. The cross section of the chambers 78 and 80 may differ from that of the magnetic strip 84. More specifically, in the embodiment depicted in FIGS. 2 and 6, the magnetic strip 34 forms a liner inside which the piston 28 or 56 moves. The cross section of the magnetic strip 34 perpendicular to the axis 16 is therefore dictated by that of the chambers 30 and 32 in the case of FIG. 1, and that of the chambers 58 and 60 in the case of FIG. 6. By contrast, in the embodiment of FIG. 7, the overall shape of the cross sections of, on the one hand, the chambers 78 and 80 and, on the other hand, the magnetic strip 84, may be different. By way of example, the chambers 78 and 80 may have a cross section of circular shape and the magnetic strip 84 a cross section of square shape.

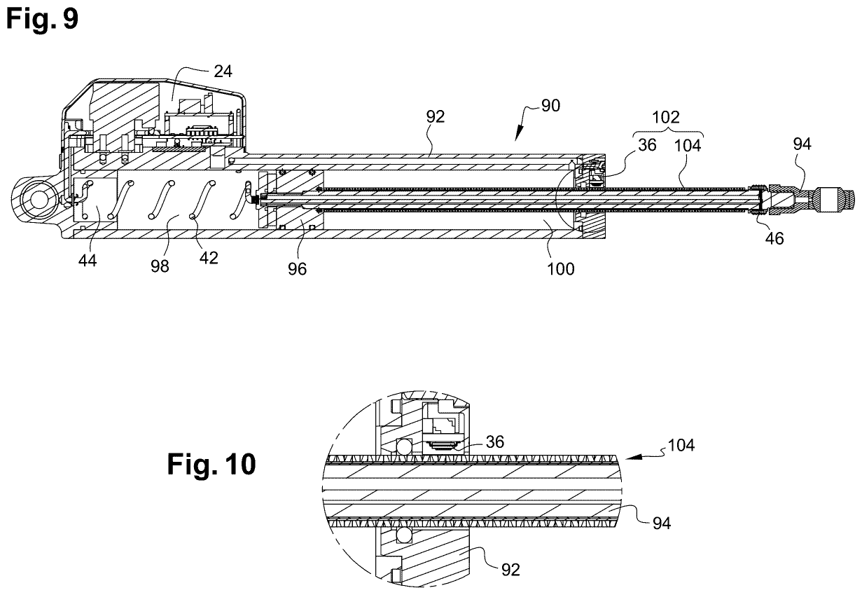

FIGS. 9 and 10 illustrate a third embodiment of the invention in which, in a cylinder actuator 90, there are once again a cylinder body 92, a rod 94, a piston 96 secured to the rod 94 and delimiting two chambers 98 and 100, and also a position sensor 102. In this embodiment, the sensitive element 36 of the position sensor 102 is secured to the cylinder body 92. The position sensor 102 also comprises a magnetic strip 104 which this time is secured to the rod 94. The magnetic strip 104 is arranged around the rod 94. As in the other embodiments, the sensitive element 36 is arranged facing the magnetic strip 104. The chief benefit of this embodiment is that it simplifies the transfer of information from the sensitive element 36 to the control module 24. In instances in which use is made of a wired connection between the sensitive element 36 and the control module 24, this connection does not require a telescopic connection 42. However, a telescopic connection 42 may prove beneficial for connecting a force sensor 46 arranged as previously on the rod 94. Once again likewise there is the volume 44 in which the telescopic connection 42 can be stowed when the rod 94 is in its position of greatest retraction into the cylinder body 92.

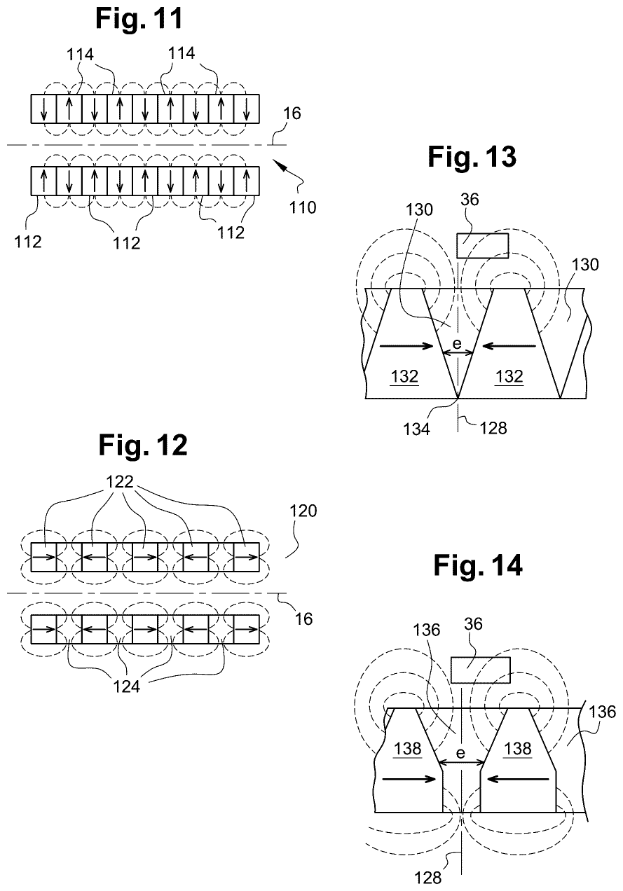

In general, the multi-pole magnetic strip as it appears in the various embodiments has, facing the sensitive element, an alternation of north and south poles. FIGS. 11 and 12 depict two embodiments of the multi-pole magnetic strip as it appears notably in FIGS. 2, 6 and 7 and which equips a cylinder actuator of which the piston moves translationally along the axis 16 with respect to the cylinder body of the cylinder actuator. The magnetic strips depicted in FIGS. 11 and 12 comprise permanent magnets. By convention, the orientation of the magnetic poles of each permanent magnet is indicated by an arrow the tip of which represents the north pole and the base of which represents the south pole. Of course the reverse convention may be chosen.

FIG. 11 depicts a magnetic strip 110 comprising permanent magnets of which the orientation of the poles is radial with respect to the axis of translation 16. The magnetic strip 110 comprises two types of permanent magnets 112 and 114 with opposite pole orientations so as to create the alternation of poles. The permanent magnets 112 have their north pole oriented toward the axis 16, and the permanent magnets 114 have their south pole oriented toward the axis 16. In order to create the alternation, each magnet 112 is in contact with a permanent magnet 114. The permanent magnets 112 and 114 have the same inside and outside diameters so as to create a cylindrical magnetic strip around the axis 16. In the example depicted, the axial dimensions or thicknesses of the two types of permanent magnets 112 and 114 are identical. Alternatively, it is possible to create magnets having different axial dimensions along the magnetic strip. In order to embody one specific position of the piston with respect to the cylinder body, it is for example possible to provide one magnet that has a different thickness than the others. Other combinations of magnet thicknesses are conceivable. In FIG. 11, some of the magnetic field lines have been indicated in dotted line, each line running between a north pole and a south pole of two consecutive permanent magnets 112 and 114. In the first embodiment of the cylinder actuator, visible in FIGS. 2 and 6, the sensitive element 36 is situated on the inside of the magnetic strip and the inner field lines, which is to say those closest to the axis 16, are exploited by the sensitive element 36. By contrast, in the second embodiment of the cylinder actuator, visible in FIG. 7, the sensitive element 36 is situated on the outside of the magnetic strip and the outer field lines, which is to say those furthest from the axis 16, are exploited.

The magnetic-strip embodiment depicted in FIG. 11 requires two distinct types of permanent magnet. It is also possible to create a magnetic strip having just one single type of permanent magnet. FIG. 12 depicts a magnetic strip 120 that achieves the alternation of north and south poles by means of a single type of magnet 122 in which the axis of the poles is oriented axially, which is to say parallel to the axis 16. In order to achieve the alternation, for each pair of consecutive magnets, the orientation of each is reversed. In order to guide the field lines on the outside and on the inside of the magnetic strip 120, the magnets 122 are all separated by a concentrator 124 containing a ferromagnetic material. In other words, the magnetic strip 120 comprises an alternation of permanent magnets 122 and of concentrators 124. As in FIG. 11, some of the magnetic field lines have been indicated in dotted line, each line running between a north pole and a south pole of the one same permanent magnet 122. These field lines pass through the concentrators 124 directly in contact with the permanent magnet 122 concerned. The thickness of the concentrators 124 is defined in such a way as to limit the repulsive effect generated by the reversal of the orientation of the poles of two consecutive permanent magnets 122. The presence of the ferromagnetic concentrators makes it possible to orient the field lines radially in a material with greater magnetic permeability than air, leading to an effect whereby the magnetic flux is concentrated radially on the outside and on the inside of the magnetic strip 120. It is possible to adapt the thickness of the concentrators 124 according to the type of sensitive element 36 employed. For example, a sensitive element of magnetostrictive type allows for a thicker concentrator than a Hall-effect sensitive element.

As previously, it is possible to create a magnetic strip having permanent magnets 122 all of the one same thickness. The same applies to the concentrators 124. For specific purposes, notably allowing a specific position of the piston to be identified, it is possible to vary the thickness of the permanent magnets 122 and/or of the concentrators 124 along the magnetic strip 120.

In the example depicted in FIG. 12, the permanent magnets 122 and the concentrators 124 each have a constant thickness defined parallel to the axis 16. Thus, there are field lines both on the inside and on the outside of the magnetic strip 120. As previously, the magnetic strip 120 may be employed by positioning the sensitive element either on the inside or on the outside of the magnetic strip 120.

FIGS. 13 to 15 depict several variants of the magnetic strip 120 that make it possible to favor one side of the magnetic strip. In these figures, the magnetic field is amplified above the magnetic field and attenuated below it. In practice, the axis 16, which has not been depicted, is horizontal and the topside of the magnetic strip corresponds to the side on which the sensitive element 36 is situated, namely either on the inside or on the outside of the magnetic strip.

In the different variants of FIGS. 13 to 15, the concentrators have a shape of which a dimension parallel to the axis 16 increases with increasing proximity to the sensitive element 36. In FIGS. 13 to 15, the increasing dimension is represented by the thickness e of the concentrator which increases with increasing proximity to the sensitive element 36. In the examples depicted in FIGS. 13 to 15, the dimension e increases symmetrically with respect to a median axis 128 separating two consecutive permanent magnets. The median axis 128 is perpendicular to the axis 16. In practice, when the magnetic strip exhibits symmetry of revolution about the axis 16, the median axis 128 is a radial axis about the axis 16. This symmetrical increase allows for a symmetrical variation in the detection of the magnetic flux by the sensitive element 36 on each side of the median axis 128. Alternatively, it may be beneficial to provide for an asymmetrical detection which is obtained by an asymmetrical increase in the dimension e on each side of the median axis 128. This asymmetry may be beneficial for example for detecting the direction of travel of the piston.

In FIG. 13, the concentrators 130 have a cross section that is triangular in a plane containing the axis 16. For a magnetic strip which overall is of tubular shape and cylindrical cross section about the axis 16, the concentrators 130 have two frustoconical surfaces which share a circular line that forms the vertex 134 of the triangle visible in FIG. 13. The permanent magnets 132 have complementary shapes allowing the magnetic strip to maintain a tubular overall shape. In the example depicted, the cross section of the permanent magnets 132 is trapezoidal in a plane containing the axis 16. It is also possible to give the permanent magnets a cross section that is triangular or to give the concentrators 130 a cross section that is trapezoidal in a plane containing the axis 16.

A number of magnetic field lines are indicated in FIG. 13. The open shape of the concentrators 130 in the direction toward the sensitive element 36 means that a stronger magnetic field can develop in the direction of the sensitive element than in the direction away from the sensitive element.

The shape of the concentrator 130 in FIG. 13 does, however, display a disadvantage at the vertex 134. At this point, the proximity of the two permanent magnets 132 has a tendency to create a strong local magnetic flux that may lead to localized saturation of the concentrator 130, rendering it inoperative near the vertex 134. Specifically, in general, there are three parameters that need to be considered in order to strengthen the magnetic field in the region of the sensitive element: On the one hand, it is desirable to increase the remanent induction of the permanent magnets 132. On the other hand, for the concentrator 130, it is desirable to increase the permeability of the material and reduce the mean thickness e thereof in order to improve the efficiency. Increasing the remanent induction of the permanent magnet 132, increasing the permeability and reducing the thickness of the concentrator 130 do, however, have the tendency to increase the size of the zone in which the material of the concentrator 130 becomes saturated.

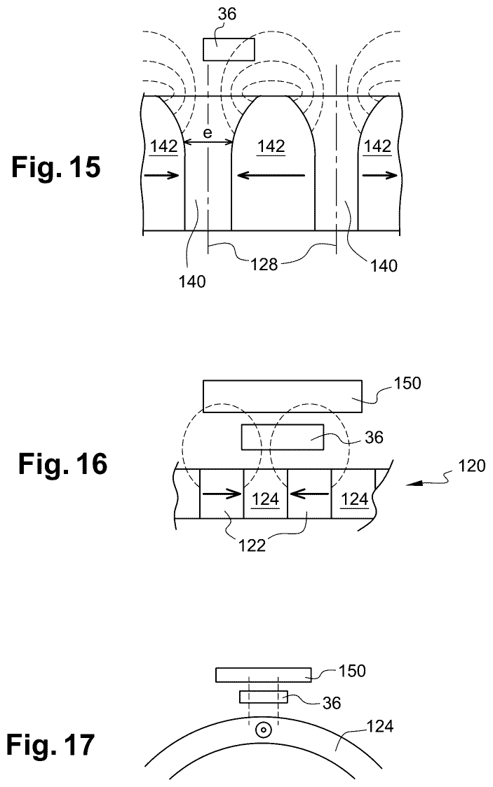

FIGS. 14 and 15 describe variants in terms of the shape of the concentrator to limit the risk of local saturation while at the same time maintaining a concentrator shape that is open toward the sensitive element 36 without excessively increasing the thickness thereof. In FIG. 14, a concentrator 136 is arranged between two permanent magnets 138 and, in FIG. 15, a concentrator 140 is arranged between two permanent magnets 142. In order to avoid excessive concentration of the magnetic field in that part of the concentrator 136 or 140 that is furthest from the sensitive element 36, the thickness e is kept constant with variable distance to the sensitive element 36. By contrast, in that part of the concentrator 136 or 140 that is closest to the sensitive element 36, the thickness e increases with greater proximity to the sensitive element 36. In FIG. 14, for the concentrator 136, the thickness e increases linearly as in the concentrator 130 of FIG. 13. In FIG. 15, for the concentrator 140, the increase in thickness e increases with increasing proximity to the sensitive element 36. The shapes of the concentrators 130, 136 and 140 are given by way of example. Other shapes that make it possible to increase the efficiency of the concentrator while limiting the risk of saturation are of course possible. The length of that part of the concentrator in which the thickness e remains constant, which length is defined along the median axis 128, may be defined empirically by measuring the magnetic field at the sensitive element 36 and on the face of the magnetic strip opposite to the sensitive element 36. This length is notably dependent on the shape and on the ferromagnetic material of the concentrators, and on the magnetic flux generated by each permanent magnet in order to avoid saturation of the concentrators.

FIGS. 16 and 17 depict a variant embodiment of a cylinder actuator according to the invention, in which an additional concentrator 150 is added. FIG. 16 is a partial view in cross section on a plane containing the axis 16, and FIG. 17 is a partial view in cross section on a plane perpendicular to the axis 16. In this variant embodiment, the magnetic strip 120 is reused. It is of course possible to use other types of magnetic strip, such as the magnetic strip 110, therein. The sensitive element 36 is arranged between the magnetic strip 120 and the additional concentrator 150 which makes it possible to concentrate certain magnetic field lines in order to limit the propagation of the magnetic field through the air. This additional concentrator, like the other concentrators arranged in the magnetic strips, comprises ferromagnetic material.

1. A cylinder actuator comprising two elements mobile one relative to the other along an axis of movement and a position sensor configured to measure the relative position of the two elements, the position sensor comprising a multi-pole magnetic strip secured to a first of the two elements and a sensitive element sensitive to magnetic-field variations and secured to a second of the two elements, the multi-pole magnetic strip having an alternation of north and south poles extending in an interval that defines a measurement range for the measurement of the relative position along the axis of movement, the sensitive element being arranged in such a way as to detect variations in the magnetic field in the vicinity of the multi-pole magnetic strip along the axis of movement within the interval.

2. The cylinder actuator as claimed in claim 1, wherein the two elements are translationally mobile one with respect to the other, the axis of movement being an axis of translation, the cylinder actuator comprising a cylinder body and a piston secured to a rod and mobile along the axis of translation with respect to the cylinder body, the piston and the multi-pole magnetic strip each having a circular cross section perpendicular to the axis of movement.

3. The cylinder actuator as claimed in claim 2, wherein the multi-pole magnetic strip comprises an alternation of permanent magnets and of concentrators comprising a ferromagnetic material, the axes of the poles of the permanent magnets being parallel to the axis of translation, the axes of the poles being oriented in opposite directions in each pair of consecutive permanent magnets separated by a concentrator.

4. The cylinder actuator as claimed in claim 3, wherein the concentrators have a shape of which a dimension (e) parallel to the axis of translation increases with increasing proximity to the sensitive element.

5. The cylinder actuator as claimed in claim 4, wherein, for each concentrator, at a part of the concentrator that is furthest from the sensitive element, the dimension (e) parallel to the axis of translation remains constant with varying distance to the sensitive element.

6. The cylinder actuator as claimed in claim 2, wherein the multi-pole magnetic strip comprises an alternation of permanent magnets, the axes of the poles of the permanent magnets being perpendicular to the axis of translation.

7. The cylinder actuator as claimed in claim 3, comprising an additional concentrator, the sensitive element being arranged between the magnetic strip and the additional concentrator.

8. The cylinder actuator as claimed in claim 1, wherein the first of the two elements comprises a cylinder body of the cylinder actuator, the second of the two elements comprising a piston and a rod which are secured to one another, the sensitive element being fixed to the piston, the cylinder actuator further comprising a telescopic connection arranged in a chamber of the cylinder actuator wherein in which chamber the piston moves, and allowing transmission, from the sensitive element toward the cylinder body, of information relating to the magnetic-field variations detected by the sensitive element.

9. The cylinder actuator as claimed in claim 8, wherein the multi-pole magnetic strip, secured to the cylinder body, forms a liner into which the piston is closely fitted.

10. The cylinder actuator as claimed in claim 8, wherein the rod of the cylinder actuator comprises a hollow internal space extending along the axis of movement and wherein the magnetic strip is formed on a finger secured to the cylinder body, the finger being arranged inside the hollow internal space.

11. The cylinder actuator as claimed in claim 8, further comprising a force sensor arranged on the rod and transmitting to the cylinder body measurements of the force exerted by the rod along the axis of movement toward the cylinder body by means of the telescopic connection.

12. The cylinder actuator as claimed in claim 1, wherein the first of the two elements comprises a piston and a rod which are secured to one another, the second of the two elements comprises a cylinder body of the cylinder actuator, the sensitive element being fixed to the cylinder body.
